(19) United States
(12) Patent Application Publication
(10) Pub. No.: US 2011/0142362 A1
(43) Pub. Date: Jun. 16, 2011

(54) METHOD FOR FILTERING DATA WITH SYMMETRIC WEIGHTED INTEGRAL IMAGES

(76) Inventor: David MARIMÓN SANJUAN, Barcelona (ES)

(21) Appl. No.: 12/635,784

(22) Filed: Dec. 11, 2009

(51) Int. Cl. G06K 9/40

(52) U.S. Cl. 382/260

(57) ABSTRACT

This patent addresses the problem of performing fast non-uniform filtering. This invention covers a form of expressing a signal with the novel Symmetric Weighted Integral Images (SWII) and a method to filter the signal with diverse kernels with a shape defined by the SWII and an arbitrary size. The main advantage of the method is that it drastically reduces the computation time.

### OBJECT OF THE INVENTION

This patent application addresses the problem of performing fast non-uniform filtering. This invention covers a form of expressing a signal with the novel Symmetric Weighted Integral Images (SWII) and a method to filter the signal with diverse kernels with a shape defined by the SWII and an arbitrary size.

### PRIOR ART OF THE INVENTION

One of the most common operations in signal and image processing is filtering. A filter can have an infinite or finite impulse response (IIR or FIR, respectively). A FIR filter is commonly expressed with a kernel function k(x) and a generic filtering operation can be expressed as

$$\hat{f} ( x ) = {\sum }_{i = 0}^{N - 1} k ( i ) \cdot f ( x - i )$$

Where f(x) is the input function to be filtered and N is the size of the kernel. One can observe that this process requires 2N memory accesses and N multiplications per sample in the input function. Several possibilities exist to alleviate this complexity. A very frequent solution to this problem is to apply separability to the kernel. For instance, in the case of two-dimensional signals, it is very common to find a filter kernel that can be separated into two smaller kernels (one per dimension) that can be consecutively applied. This solution reduces the computational complexity especially for small sized kernels. A different arrangement can be taken when the kernel has a uniform shape or at least piece-wise uniform (Haar wavelet). In this case, the filtering operation turns into a sum of f(x) weighted by the uniform value of the kernel. By pre-computing the running sum of f(x), the filtering process is reduced to accessing the running sum only at the two extreme points. For two-dimensional signals, this two-dimensional running sum is known as integral image and filtering is reduced to four accesses.

Among other applications, many computer vision frameworks use non-uniform filtering to detect or describe features such as salient points or lines. The advantage of non-uniform filters is that more relevance can be given along a certain direction or to the central pixels of a patch (see references, [7,8]). For instance, this has interesting properties for viewpoint invariance of a descriptor since samples away from the centre are prone to change with different viewpoints (reference [6]).

The object of this invention is exploiting the benefits of fast filtering with integral images while addressing the desired property of non-uniform kernels. A novel set of pre-computed integrals named Symmetric Weighted Integral Images (SWII) are introduced and the flexible filtering process that derives from them is also described. The technique shows further reduction of the number of memory accesses when compared to similar techniques. The main advantage of the method is that it drastically reduces the computation time.

The first method to perform fast box filtering on images was introduced by Crow (reference [2]) under the name Summed-Area Tables. Later, Viola and Jones ported this concept to computer vision for fast computation of Haar wavelet responses (reference [10]). The first step consists in pre-computing the integral image

$$ii ( x , y ) = {\sum }_{i \leq x , j \leq y} f ( i , j )$$

As stated before, filtering can then proceed by accessing only four samples of ii(x,y). More precisely, the filtered output of f(x+[N/2], y+[M/2]) for a box kernel of size N×M (with N and M being odd numbers) can be computed with the following addition:

R(x,y,N,M,ii)=ii(x+N,y+M)+ii(x,y)−ii(x+N,y)−ii(x,y+M)

Note that R implies 4 memory accesses.

Although very fast, integral images have had limited usage due to the uniform shape of the filter. Heckbert addressed this problem by generalising the theory behind integral images and presented a framework for non-uniform filters. The main observation that Heckbert did was that a convolution of a function f and g is equivalent to a convolution of fₙ (n times repeated integration of f) with gₙ (n times derivation of g)

$$f * g = ( {\int }^{n} f ( x ) d x ) * ( \frac{{\partial }^{n} g ( x )}{\partial {x}^{n}} )$$

Heckbert proposes to approximate a kernel function by the n times repeated convolution of a box filter (box*ⁿ). For an increasing n the kernel approximates a Gaussian filter. From reference [3], the n times derivation of the n times convolution is:

$$\begin{matrix}{( {box}^{* n} )}_{{n}^{′}} ( x ) = {( {box}^{′} )}^{* n} ( x ) \\ = {N}^{- n} {\sum }_{i = 0}^{n} {( - 1 )}^{i} ( \begin{matrix}n \\ i\end{matrix} ) δ ( x + ( \frac{n}{2} - i ) \cdot N )\end{matrix}$$

where N is the length of the kernel and δ(x) is a discrete impulse function. The filtering can then be computed by only accessing n+1 (in the one-dimensional case) samples of fₙ.

For instance, a one-dimensional Bartlett filter (n=2) needs only 3 samples of the second integral of the input signal, regardless of the size of the kernel. The application of the repeated integration method is limited by the high numerical precision needed even for small sizes of the data and levels of integration. For an image of size W×H pixels, the precision is n(log₂(W)+log₂(H))+Pᵢ where Pᵢ is the precision needed for the input data. For instance for a Bartlett filter and an image of size 512×512 with 8-bit precision, the integral image must have 44 bits of precision.

More recently, Hussein et al. (reference [4]) proposed another method for filters with non-uniform kernel shape. The method is called Kernel Integral Images (KII) and consists in finding the linear combination of simple functions and the corresponding weighting factors that generate, or approximate, the desired kernel shape. The key issue is to find simple functions that are region-independent and hence their integral image can be computed. In order to generate the response to the desired kernel, the integral image of each of those functions is pre-computed and then accessed for fast filtering. Compared to repeated integration, in Kernel Integral Images the precision is required only for higher order functions that appear in the expansion of a desired kernel function. This commonly happens when a simple function grows quadratically with the range of samples. Another important aspect is the limited applicability of the filter when the expansion and truncation is only valid for a reduced range of values. Indeed, in some cases the expansion of the kernel function would give rise to an infinite number of integral images. Therefore, truncation is needed and the truncated approximation is only valid for a limited number of cases.

Another possibility to perform fast non-uniform filtering is to exploit the redundancy in the weights of the kernel (reference [9]). Prior to filtering, two structures must be built from the information of an arbitrary kernel: the links and the corresponding weights. The links identify which coordinates are affected by a given weight. The weight is the multiplicative factor that affects all the linked coordinates. Filtering can proceed with either single input access or single output access. In the single input access method, the input image is scanned only once. The contribution of each pixel is distributed according to the links and the corresponding weight into the output (filtered) image. In other words, the output is accessed the number of links per weight times the number of different weights. This approach is very useful when the amount of available memory is limited. The single output access is very similar in conception to standard filtering. For each element of the output image, all the points in the input image are accessed using the links and multiplied by the corresponding weight. As it can be deduced, the more redundant coefficients in the kernel the higher the computational savings of the method. Although test shows much lower computational complexity of this method as compared to conventional filtering for several kernel shapes, there are two main drawbacks. The first one is that the computational gain depends on the redundancy in the coefficients. This redundancy decreases as the size of the kernel increases. The second one is that the computation of the links and weights must be performed for a given size. Therefore, whenever the size of the kernel changes, this process has to be performed again. This is particularly relevant for multi-scale filtering.

### DESCRIPTION OF THE INVENTION

Symmetric Weighted Integral Images (SWII) are integral images for which the contribution of each sample of the input function is weighted. The weighting is a slope of increasing or decreasing value. SWII are designed with the specific purpose of filtering with a set of non-uniform kernel shapes. The shape of the kernel must be defined or approximated, completely or by segments, with additive slopes of increasing or of decreasing weight.

Although all the description that follows is expressed for the 2D case, it is easily extensible to multiple dimensions. Five SWII are defined for a function f(x,y)ε R where (x,y)ε[1,W]×[1,H] with the following shapes:

$${S}_{0} ( x , y ) = ii ( x , y ) = {\sum }_{i \leq x , j \leq y} f ( i , j )$$

$${S}_{x} ( x , y ) = {\sum }_{i \leq x , j \leq y} ( i - x ) f ( i , j )$$

$${S}_{- x} ( x , y ) = {\sum }_{i \leq x , j \leq y} ( x - i + 1 ) f ( i , j )$$

$${S}_{y} ( x , y ) = {\sum }_{i \leq x , j \leq y} ( j - y ) f ( i , j )$$

$${S}_{- y} ( x , y ) = {\sum }_{i \leq x , j \leq y} ( y - j + 1 ) f ( i , j )$$

Those five SWII are necessary for two-dimensional filtering. In the one-dimensional case, only three SWII functions are needed, namely, S₀, Sₓ and S₋ₓ.

In the multidimensional case, the SWII for k=1, . . . , L (where L is the number of dimensions) as follows:

$${S}_{0} ( {x}_{1} , … , {x}_{L} ) = {\sum }_{{i}_{1} \leq {x}_{1} … {i}_{L} \leq {x}_{L}} f ( {i}_{1} , … , {i}_{L} )$$

$${S}_{{x}_{k}} ( {x}_{1} , … , {x}_{L} ) = {\sum }_{{i}_{1} \leq {x}_{1} … {i}_{L} \leq {x}_{L}} ( {i}_{k} - {x}_{k} ) f ( {i}_{1} , … , {i}_{L} )$$

$${S}_{- {x}_{k}} ( {x}_{1} , … , {x}_{L} ) = {\sum }_{{i}_{1} \leq {x}_{1} … {i}_{L} \leq {x}_{L}} ( {x}_{k} - {i}_{k} + 1 ) f ( {i}_{1} , … , {i}_{L} )$$

for which the contribution of each sample of the input function is weighted.

As described in the previous section, one of the limitations in the applicability of references [3] and [4] is the precision needed to store the integrals. In our case, the precision needed for S₀ is log₂(W)+log₂(H)+Pᵢ. For instance, for an image of size 512×512 with 8-bit precision, 26 bits are needed. For S_{X} and S₋ₓ, the precision (assuming W>>1) is approximated with 2·log₂(W)−1+log₂(H)+Pᵢ. Similar formulation follows the case of S_{y} and S_{-y}. Using the data of the previous example, the precision needed is 34 bits.

SWII can be used for fast filtering in a similar fashion to integral images. There are two main goals in the design of SWII for filtering. First, flexibility in the shape of the desired non-uniform kernel function. Second, a reduction of the amount of memory accesses by exploiting redundancies in the accessed samples of the SWII.

The method that uses the SWII for filtering comprises the following steps:
i. To compute the SWII for the signal that is being filtered.
ii. To define at least one desired kernel composed by at least one slope of increasing or decreasing weight, obtaining a kernel which uses at least one of the weights defined by the SWII.
iii. To compute the filtered output signal by accessing the SWII corresponding to the kernel defined in the previous step.

Steps ii) and iii) can be performed for several kernels of different shape. For a given kernel, different sizes can be defined. In this case, it is only necessary to repeat step iii) as many times as different sizes are defined.

This reuse of the computation of SWII (step 1 only done once for a given signal) is one of the advantages of this invention.

SWII are designed with the specific purpose of filtering with a set of kernel shapes. The shape must be defined or approximated, completely or by segments, with slopes of increasing or of decreasing weight.

### BRIEF DESCRIPTION OF THE FIGURES

FIG. 1: Example kernels for N=21, M=27. (a) Triangle-shaped kernel. (b) Pyramid-shaped kernel.

FIG. 2: Comparison of the speedup gained with KII and with the proposed SWII for different kernel sizes (note that N=M). [symbol] Kernel Integral Images. [symbol] Symmetric Weighted Integral Images.

FIG. 3: Comparison of the speedup gained with KII and with the proposed SWII in multi-scale filtering. The results consider the pre-computation of the necessary integrals. [symbol] Kernel Integral Images. [symbol] Symmetric Weighted Integral Images.

FIG. 4: Two weighted slopes (top) positive, (bottom) negative. The addition of both gives the approximate shape of the 2nd order Gaussian derivative with SWIIs in x direction.

FIG. 5: Second order derivative of Gaussian kernel (σ=3.6, N=27) and evaluated approximations (N=27). (a) 2nd derivative of Gaussian. (b) Approximation with integral images (reference [1]). (c) Approximation with SWII.

FIG. 6: RMSE between ∂²G/∂×² and DₓₓG approximated with integral images (reference [1]) and with SWII. [symbol] Kernel Integral Images. [symbol] Symmetric Weighted Integral Images.

### EXAMPLES

This section is devoted to describe several kernel shapes and the benefits of SWII over other techniques explained before.

The output of the filtering will be referred to f(x+[N/2],y+[M/2]). From now on, computational complexity per output sample is indicated as C(a,b,c) where a is the number of memory accesses, b, the additions, and c, the multiplications.

### Example 1

### Application of the SWII Method with a Kernel Increasing and Decreasing in the x Direction

For a kernel increasing in the x direction, filtering would be performed with the following addition of SWII functions

$${\sum }_{{x < i \leq x + N}_{y < j \leq y + M}} ( i - x ) f ( x , y ) = R ( x , y , N , M , {S}_{x} ) + N ( {S}_{0} ( x + N , y + M ) - {S}_{0} ( x + N , y ) )$$

This process needs C(6,5,1). The addition for the kernel decreasing in the x direction is slightly different:

$${\sum }_{{x < i \leq x + N}_{y < j \leq y + M}} ( x + N + 1 - i ) f ( x , y ) = R ( x , y , N , M , {S}_{- x} ) + N ( {S}_{0} ( x , y ) - {S}_{0} ( x , y + M ) )$$

### Example 2

### Application of the SWII Method with a Triangle Kernel in the x Direction

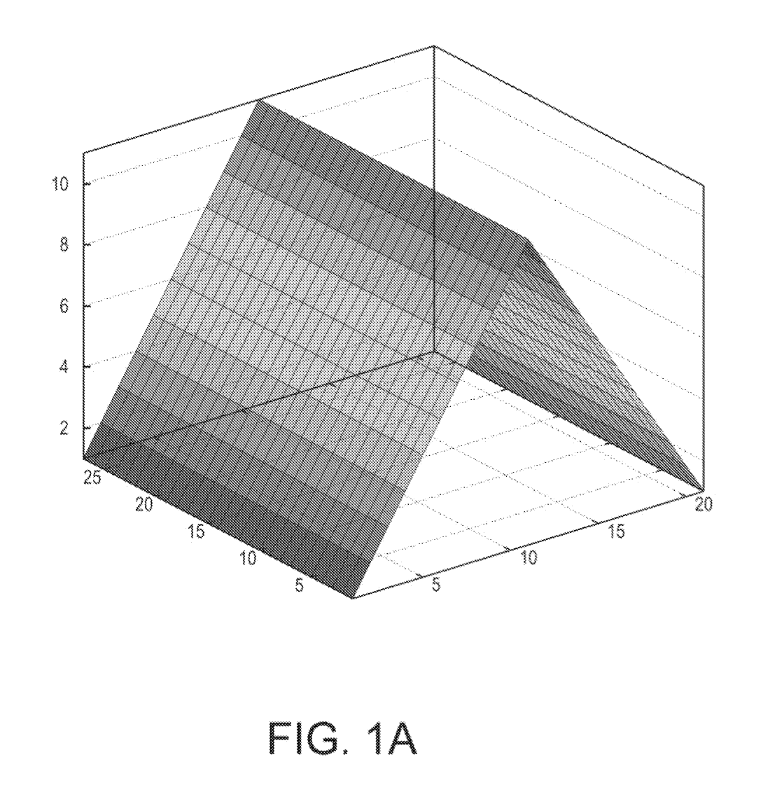

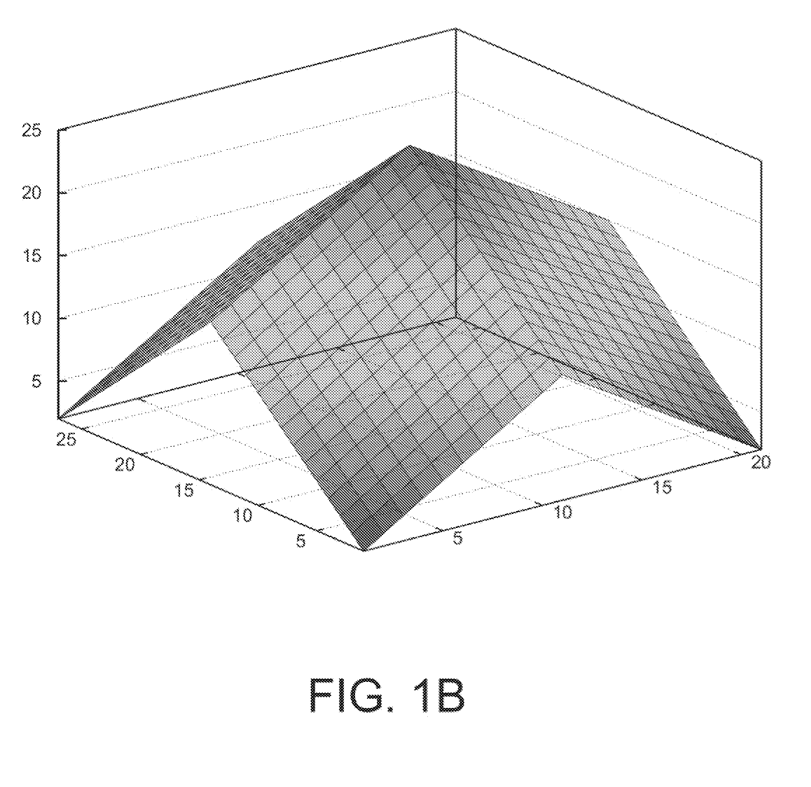

If the performance for a triangle kernel in the x direction (see FIG. 1(a)) is evaluated, filtering can be performed with the following addition:

$${\sum }_{{x < i \leq x + N}_{y < j \leq y + M}} ( ⌈ \frac{N}{2} ⌉ - \vert ⌈ \frac{N}{2} ⌉ + x - i \vert ) f ( x , y ) = R ( x , y ⌈ \frac{N}{2} ⌉ , M , {S}_{x} ) + R ( x + ⌈ \frac{N}{2} ⌉ , y , ⌈ \frac{N}{2} ⌉ , M , {S}_{- x} ) + {S}_{0} ( x + ⌈ \frac{N}{2} ⌉ , y + M ) - {S}_{0} ( x + ⌈ \frac{N}{2} ⌉ , y )$$

This process needs C(10,9,0).

### Example 3

### Application of the SWII Method with a Pyramid-Shaped Kernel

In order to filter with a pyramid-shaped kernel (see FIG. 1(b)), it is possible to add up the previous triangle kernel in x and y directions with only C(20,19,0). As it can be deduced, other kernels can be built by translating, overlapping, and adding increasing or decreasing slopes.

In a filtering process there should be no offset added to the result. Therefore, the sum of all the weights in a kernel should be 1. In order to normalise the kernels built with SWII, the following equality can be used

$${\sum }_{i = 1}^{n} i = n ( n + 1 ) / 2$$

As an example, the normalisation factor for the kernel shown in FIG. 1(a) would be M·N·(N+1)/2. In the later example of the pyramid shape, the normalisation would be

$$M ⌈ \frac{N}{2} ⌉ ( ⌈ \frac{N}{2} ⌉ + 1 ) / 2 + M ⌊ \frac{N}{2} ⌋ ( ⌊ \frac{N}{2} ⌋ + 1 ) / 2 + N ⌈ \frac{M}{2} ⌉ ( ⌈ \frac{M}{2} ⌉ + 1 ) / 2 + N ⌊ \frac{M}{2} ⌋ ( ⌊ \frac{M}{2} ⌋ + 1 ) / 2$$

### Comparative Examples

In order to evaluate the performance of filtering with SWII several experiments have been performed. As stated in the previous section, the design of SWII enables a speed up in comparison to other non-uniform filtering techniques. Moreover, SWII can prove to be a valid approximation to other more common filters. The following sections cover the experiments to assess those properties.

### Example 1

### Comparison Between SWII and Kernel Integral Images Using Reshuffling Method with a Pyramid-Shaped Kernel and Standard Convolution

A comparison is performed for the kernel shape shown in FIG. 1(b) pyramid filtering with standard convolution, using the Reshuffling method (reference [9]), Kernel Integral Images (KII) (reference [4]) and SWII. The unnormalised kernel k(x,y) [symbol] have performed where (x,y)ε[1,N]×[1, M] can be expressed mathematically as follows

$$k ( x , y ) = ⌊ \frac{N}{2} ⌋ - \vert x - ⌊ \frac{N}{2} ⌋ \vert + ⌊ \frac{M}{2} ⌋ - \vert y - ⌊ \frac{M}{2} ⌋ \vert$$

The elements of this kernel would be pre-computed for a given N and M. With such prior information stored, filtering would need C(2·N·M+1,N·M−1,N·M).

Filtering with Reshuffling demands the pre-computation of the links and weights. This offline procedure is independent of the size of the image and is here considered negligible. The number of redundant coefficients is

$$U = ⌊ \frac{N}{2} ⌋ - ⌊ \frac{M}{2} ⌋ - 1.$$

According to reference [9] the complexity per output sample is C(2·N·M+1,N·M,U). Filtering with such a kernel using KII demands three integral images, namely K₀(x,y)=ii(x,y),

$${K}_{x} ( x , y ) = {\sum }_{i \leq x , j \leq y} i \cdot f ( i , j )$$

$${K}_{y} ( x , y ) = {\sum }_{i \leq x , j \leq y} j \cdot f ( i , j )$$

The complexity of the time taken to build the integrals and filtering is summarised in the next table in wherein is showed the pre-computation and filtering complexity for a pyramid-shaped filter with the computational complexity expressed as C(memory accesses, additions, multiplications) per sample on a 2D array and the number of memory accesses include the access to the destination array. Note that normalisation is not included as it can be performed with the same complexity, for example 1 division per sample, regardless of the sort of filtering technique. In the case of filtering with KII, the configuration of functions taken that has the least possible number of memory accesses to filter with the same pyramid-shaped kernel.

$$\frac{\begin{matrix} & \begin{matrix}Pre \text{-} \\ computation\end{matrix} & Filtering\end{matrix}}{\begin{matrix}KII & C ( 13 , 6 , 2 ) & C ( 21 , 28 , 16 ) \\ SWII & C ( 17 , 10 , 6 ) & C ( 21 , 19 , 0 )\end{matrix}}$$

In order to evaluate the total complexity of those three techniques, the relative cost of memory accesses, multiplications and additions an integer addition is utilised. Following the analysis presented in reference [9] and fix a relative cost of 9 for each memory access (including array indexing and one addition per access) on a 2D array, 4 for an integer multiplication, and 1 for an integer addition.

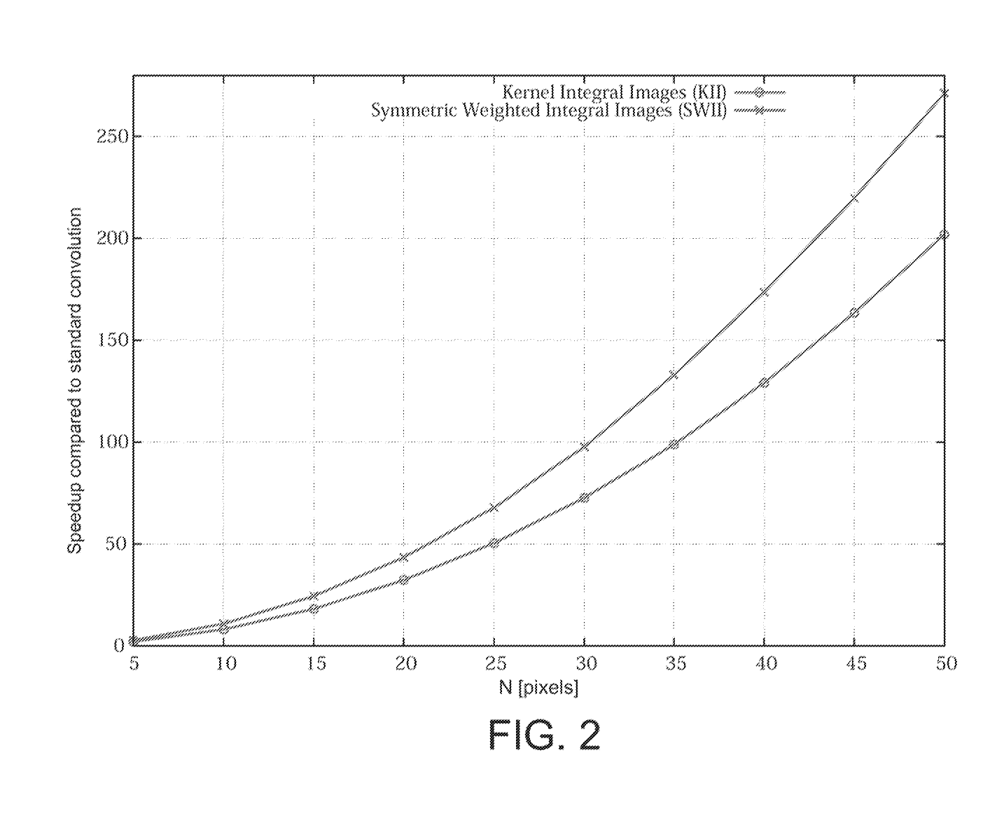

The speedup factor (in example xfaster) of KII and SWII filtering is compared to conventional convolution for different values of N (considering N=M). The results are shown in FIG. 2. Obviously, the advantage of both integral image-based techniques grows with the size of the kernel. This analysis shows that the improvement of SWII over KII grows exponentially.

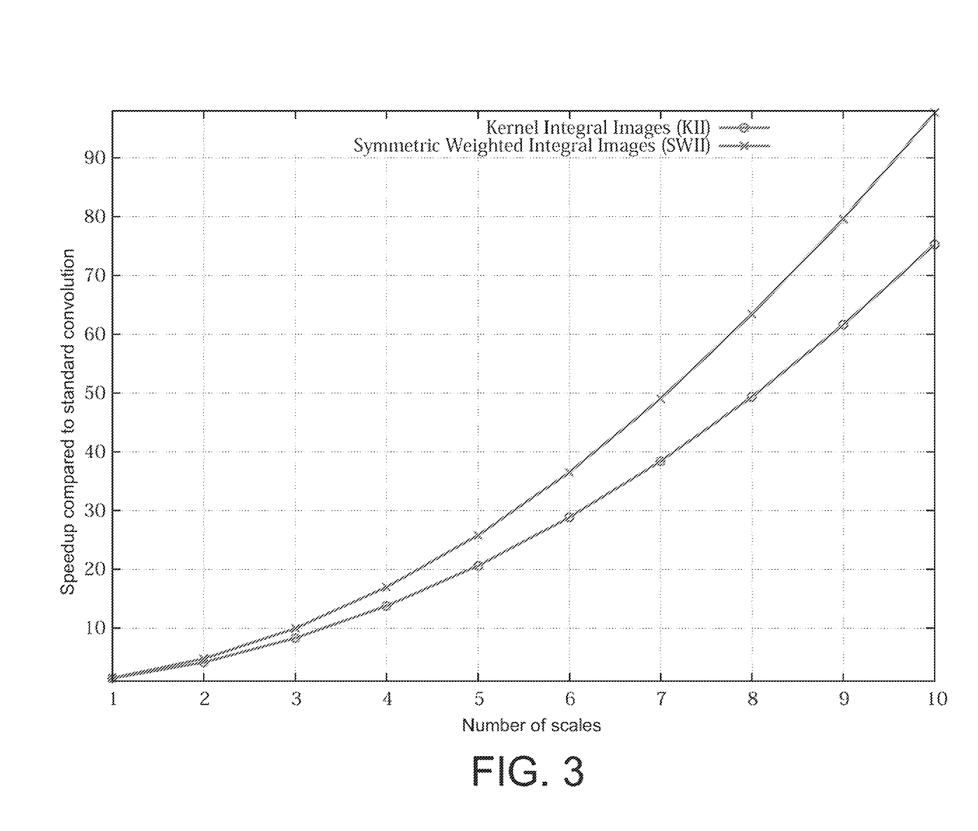

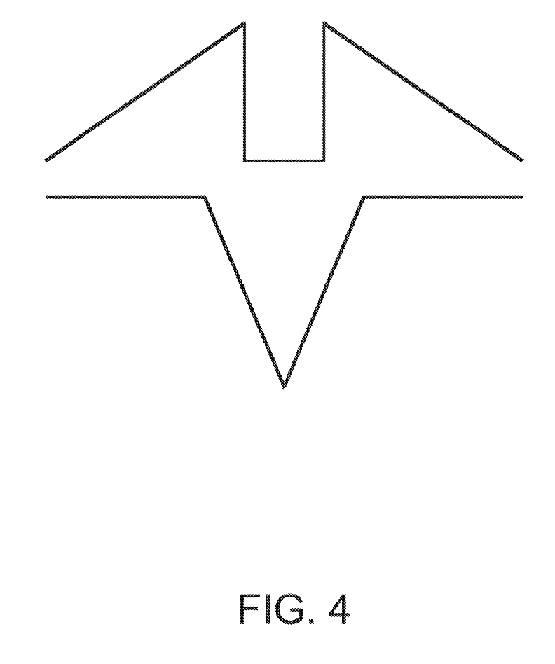

A non-negligible computational aspect of any II-based algorithm is the time spent to pre-compute the integrals. This lapse is worth especially when an image is filtered several times, for instance in multi-scale filtering. Indeed, a major advantage of II-based filtering is that multiple scales can be filtered with no extra pre-computation. Proceeding with an evaluation of the speedup achieved in multi-scale filtering. The kernel size (N×M) is chosen to start with 5×5 pixels and is incremented at each scale by steps of 5×5 pixels. FIG. 3 shows the speedup for different number of scales with KII and SWII, including the time taken to build the integrals.

As it can be seen, the speedup achieved when considering also the pre-computation of the integrals is much lower than when considering only filtering. Nevertheless, the advantage of SWII over conventional and KII filtering is clearly shown for an increasing number of scales.

In the case of the Reshuffling method, the speed up factor ranges from 1.1 to 1.5, both for different kernels sizes and for multiple scales.

### Example 2

### Use of Gaussian Derivatives for the Purpose of Salient Point Detection

This section is devoted to validate the applicability of the proposed method to build kernels that are used in computer vision algorithms. More precisely, taking the example of Gaussian derivatives for the purpose of salient point detection (reference [5]). In our evaluation, the approximation of the second derivative in x taken in Bay (reference [1]) using integral images, is compared to the approximation taken using SWII. Note that N=M in the remaining of this section. Our approximation is based on the combination of several partially overlapping weighted slopes. The approximation in the x direction for the range xε[1,N] is depicted graphically in FIG. 4.

A triangle (see FIG. 1(a)) in the range

$$y ∈ [ ⌈ \frac{N}{2} ⌉ - \frac{N}{3} + 1 , ⌊ \frac{N}{2} ⌋ + \frac{N}{3} ]$$

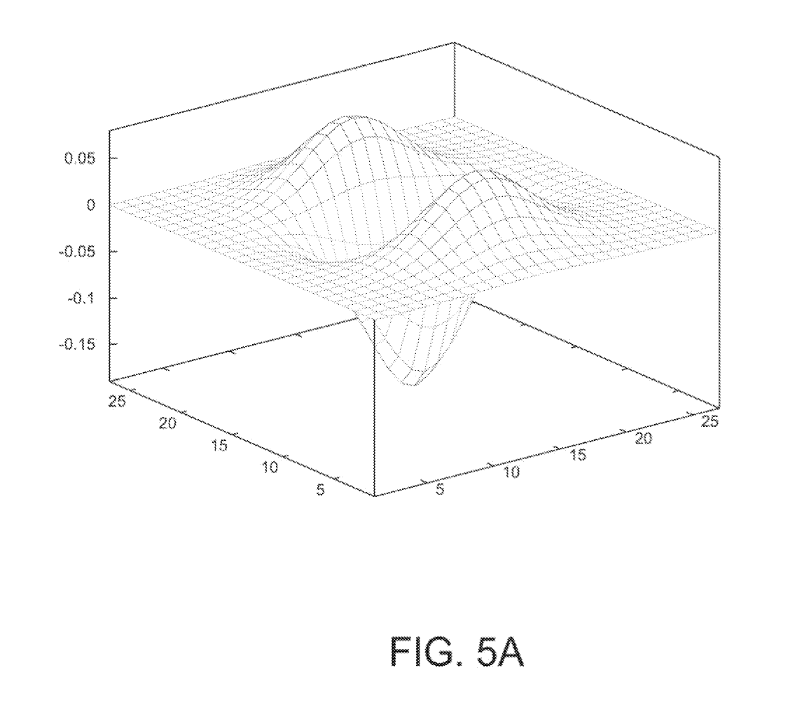

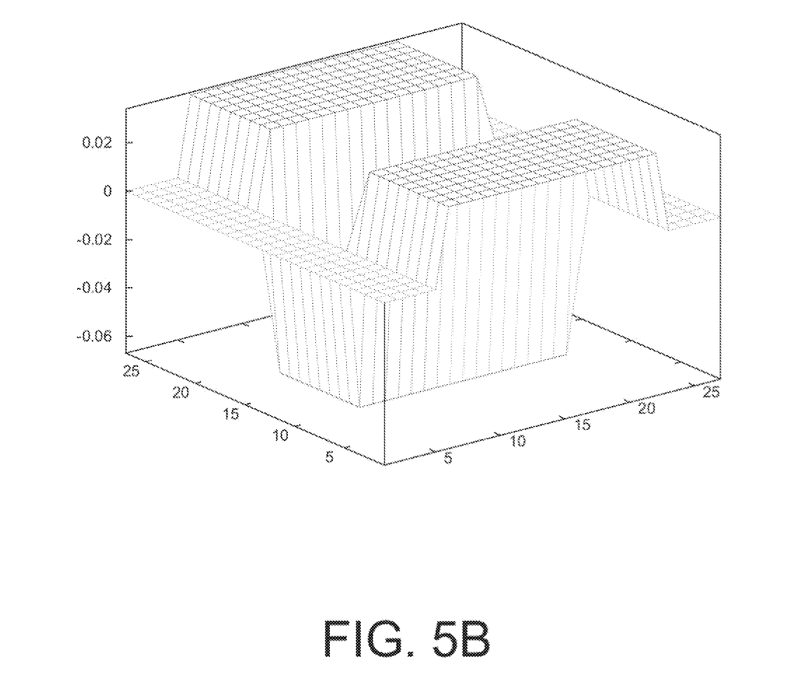

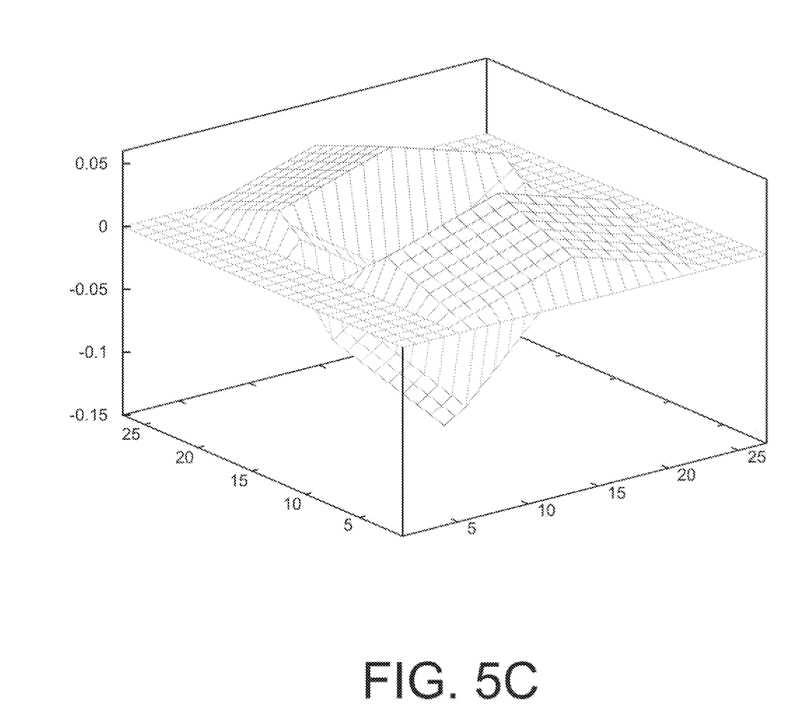

is added to build the desired shape. Note that weights are chosen so that the sum of all samples is ≅0. FIG. 5 shows the second derivative of a Gaussian kernel in the x axis, and the corresponding approximations. The particular shape constructed with SWII is the outcome of a tradeoff between an approximation to a 2nd order Gaussian derivative and a desired limitation in the number of memory accesses. In fact, it could be possible to achieve a better approximation by overlaping more slopes with different weights.

The metric used to compare the accuracy of the two approximations is the Root Mean Square Error (RMSE). This error is computed between the reference Gaussian derivative kernel and the corresponding approximation kernels. All kernels are normalised with their Frobenius norm. The 2nd order Gaussian derivative in x is obtained as follows:

$$G ( x , y ) = {e}^{\frac{{x}^{2} + {y}^{2}}{2 {σ}^{2}}}$$

$$\frac{{\partial }^{2} G}{\partial {x}^{2}} ≅ {D}_{xx} G = G ( x + 1 , y ) - 2 \cdot G ( x , y ) + G ( x - 1 , y )$$

This approximation is very common and corresponds to separating the Gaussian filtering from the derivation process. Indeed, it is common to perform several derivatives over an image, for instance, ∂x², ∂y² and ∂xy. In this case, it is more convenient to apply filter separability and perform first a single pass over the image with a Gaussian filter. Then, compute all the necessary derivatives. Separability is considered here since it is very frequent for the salient point detection example that has been focused in.

Bay et al. (reference [1]) state that the best approximation for a kernel of σ=1.2 is obtained with a size N=9. The authors propose to build all other kernels following the ratio σ_{N}=1.2·N/9. In our case, the best approximation for N=9 is obtained with a Gaussian of σ=1.4·N/9. Consequently, all other sizes follow the ratio σ_{N}=1.4·N/9.

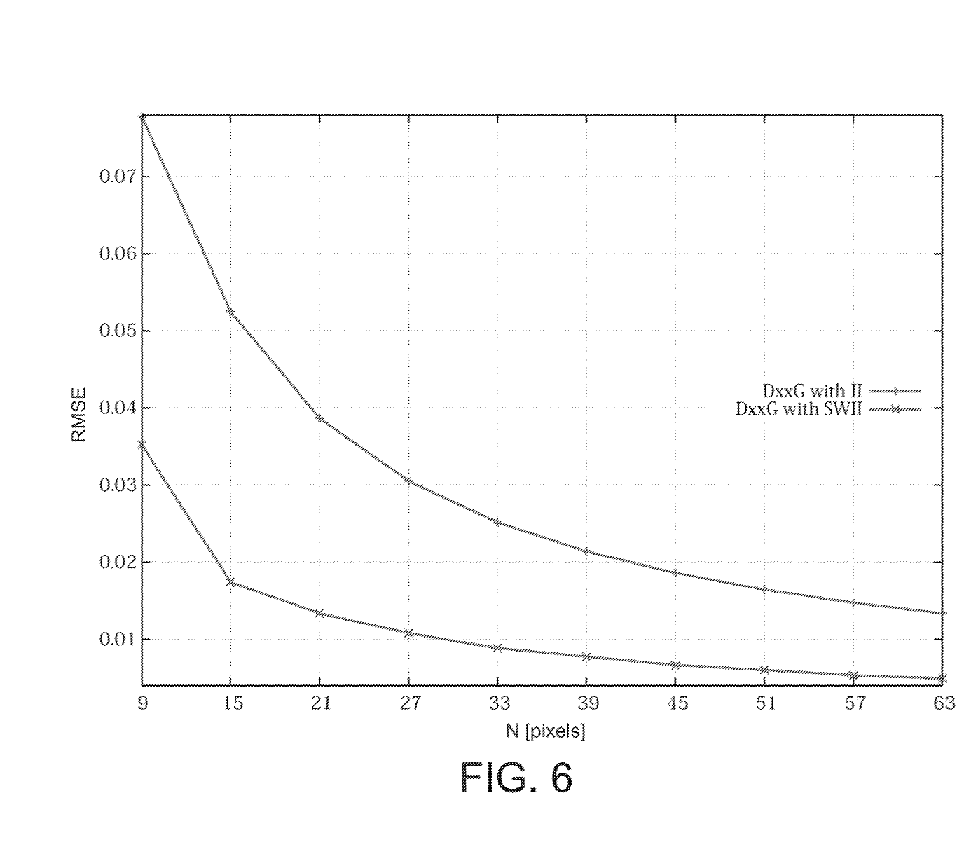

The results of computing the RMSE as described above are depicted in FIG. 6.

Observation of this plot shows the improved accuracy of SWII over integral images following the structure proposed in reference [1]. This effect is particularly larger for small kernel sizes. Depending on the application, the improvement of accuracy is worth the increased computation time needed for the SWII. Nevertheless, it must be pointed out that with a single pre-computation of SWII, an image could be derived with approximations of 1st and 2nd order Gaussian derivatives in both x and y directions.

### CONCLUSIONS

A novel technique has been proposed to perform non-uniform filtering exploiting the fast performance of integral images. The proposed Symmetric Weighted Integral Images (SWII) can be used to build a variety of kernel shapes by combining monotonically increasing/decreasing weights. Several 2D examples with the corresponding computational complexity have been described.

The method has been compared to similar techniques in terms of computational efficiency and applicability to computer vision. The results show the improvement over Kernel Integral Images, including pre-computation. The experiments have also shown the especially relevant speedup when SWII are applied to a multi-scale filtering framework. The accuracy of the approximation of SWII and integral images as in reference [1] Gaussian derivatives has been evaluated. Results show larger exactitude of SWII notably for small kernel size

### REFERENCES

[1] H. Bay, T. Tuytelaars, and L. Van Gool. SURF: Speeded Up Robust Features. In Proc. Euripean Conference on Computer Vision (ECVV), May 2006.
[2] F. Crow. Summed-area tables for texture mapping. In Proc. Computer Graphics (SIGGRAPH), volume 18, pages 207-212, July 1984.
[3] P. Heckbert. Filtering by repeated integration. In Proc. Computer Graphics (SIGGRAPH), volume 20, pages 315-321, 1986.
[4] M. Hussein, F. Porikli, and L. Davis. Kernel integral images: A framework for fast non uniform filtering. In IEEE Conf. on Computer Vision and Pattern Recognition (CVPR), June 2008.
[5] T. Lindeberg. Scale-space Theory in Computer Vision. Kluwer, 1994.
[6] D. Lowe. Distinctive image features from scale-invariant keypoints. Intl. Journal of Computer Vision, 60(2):91-110, 2004.
[7] K. Mikolajczyk and C. Schmid. A performance evaluation of local descriptors. IEEE Trans. on Pattern Analysis and Machine Inteligence, 27(10):1615-1630, 2005.
[8] K. Mikolajczyk, T. Tuytelaars, C. Schmid, A. Zisserman, J. Matas, F. Schaffalitzky, T. Kadir and L. Van Gool. A comparison of affine region detectors. Intl. Journal of Computer Vision, 65(1/2):43-72, 2005.
[9] F. Porikli. Reshuffling: a fast algorithm for filtering with arbitrary kernels. In SPIE Electronic Imagining Conference on Real-Time Image Processing, volume 6811, 2008.
[10] P. Viola and M. Jones. Rapid object detection using a boosted cascade of simple features. In Proc. IEEE Conf on Computer Vision and Pattern Recognition (CVPR), volume 1, pages 511-518, 2001.

1. Fast non-uniform filtering method of signals with Symmetric Weighted Integral Images (SWII) which comprises the following steps:
i. computing the SWII for the signal that is being filtered,
ii. defining at least one desired kernel composed by at least one slope of increasing or decreasing weight, obtaining a kernel which uses at least one of the weights defined by the SWII,
iii. computing the filtered output signal by accessing the SWII corresponding to the kernel defined in the previous step.

2. Fast non-uniform filtering method according to claim 1 wherein step i) in case of multidimensional filtering computes the SWII for k=1, . . . , L (where L is the number of dimensions) as follows:
$${S}_{0} ( {x}_{1} , … , {x}_{L} ) = {\sum }_{{i}_{1} \leq {x}_{1} … {i}_{L} \leq {x}_{L}} f ( {i}_{1} , … , {i}_{L} )$$
$${S}_{{x}_{k}} ( {x}_{1} , … , {x}_{L} ) = {\sum }_{{i}_{1} \leq {x}_{1} … {i}_{L} \leq {x}_{L}} ( {i}_{k} - {x}_{k} ) f ( {i}_{1} , … , {i}_{L} )$$
$${S}_{- {x}_{k}} ( {x}_{1} , … , {x}_{L} ) = {\sum }_{{i}_{1} \leq {x}_{1} … {i}_{L} \leq {x}_{L}} ( {x}_{k} - {i}_{k} + 1 ) f ( {i}_{1} , … , {i}_{L} )$$
for which the contribution of each sample of the input function is weighted.

3. Fast non-uniform filtering method according to claim 2 wherein step i) in case of two dimensional filtering computes the SWII as follows:
$${S}_{0} ( x , y ) = ii ( x , y ) = {\sum }_{i \leq x , j \leq y} f ( i , j )$$
$${S}_{x} ( x , y ) = {\sum }_{i \leq x , j \leq y} ( i - x ) f ( i , j )$$
$${S}_{- x} ( x , y ) = {\sum }_{i \leq x , j \leq y} ( x - i + 1 ) f ( i , j )$$
$${S}_{y} ( x , y ) = {\sum }_{i \leq x , j \leq y} ( j - y ) f ( i , j )$$
$${S}_{- y} ( x , y ) = {\sum }_{i \leq x , j \leq y} ( y - j + 1 ) f ( i , j )$$
for which the contribution of each sample of the input function is weighted.

4. Fast non-uniform filtering method according to claim 1 wherein step i) in case of one dimensional filtering computes the SWII as follows:
$${S}_{0} ( x ) = ii ( x ) = {\sum }_{i \leq x} f ( i )$$
$${S}_{x} ( x ) = {\sum }_{i \leq x} ( i - x ) f ( i )$$
$${S}_{- x} ( x ) = {\sum }_{i \leq x} ( x - i + 1 ) f ( i )$$
for which the contribution of each sample of the input function is weighted.

5. Fast non-uniform filtering method according to claim 1, wherein in step ii) the image is filtered using SWII with a set of non-uniform kernel shapes which are defined completely or by segments with additive slopes of increasing or of decreasing weight.

6. Fast non-uniform filtering method according to claim 1, wherein the weighting is a slope of increasing or decreasing value.
